(19) United States
(12) Patent Application Publication
(10) Pub. No.: US 2015/0270914 A1
(43) Pub. Date: Sep. 24, 2015

(54) Multiple Channel Audio Receiver

(71) Applicant: MYE Entertainment, Inc., Stevenson Ranch, CA (US)

(72) Inventors: Ronald G. Pace, Naperville, IL (US); Anthony E. Garcia, Stevenson Ranch, CA (US)

(73) Assignee: MYE Entertainment, Inc., Stevenson Ranch, CA (US)

(21) Appl. No.: 14/552,774

(22) Filed: Nov. 25, 2014

Related U.S. Application Data
(60) Provisional application No. 61/909,778, filed on Nov. 27, 2013.

(51) Int. Cl. H04H 20/08; H04R 3/12; H04H 20/61; H04H 20/71

(52) U.S. Cl. CPC H04H 20/08; H04H 20/71; H04R 3/12; H04H 20/61

(57) ABSTRACT

A signal control system is provide and includes a signal source, a receiving device configured to receive a signal from the signal source, a processing device communicated with the receiving device to receive and process the signal to generate a processed signal and a transmitting device communicated with the processing device, wherein the transmitting device is configured to wirelessly transmit the processed signal.

### CROSS REFERENCE TO RELATED APPLICATIONS

This application is related to and claims the benefit of the filing date of U.S. Provisional Patent Application Ser. No. 61/909,778 filed Nov. 27, 2013, the contents of which are incorporated herein by reference in its entirety.

### FIELD OF THE INVENTION

The present invention relates generally to audio receivers and more specifically to audio receivers for use within the fitness industry where the audio receivers may include multiple RF receivers that are tunable across frequency channels to receive, demodulate and/or decode base band audio information.

### BACKGROUND OF THE INVENTION

The majority of health and fitness facilities worldwide provide televisions (TVs) in the cardio machine area of their clubs for club members performing cardio exercises to watch while working out. These TVs are typically mounted on the ceiling or wall directly in front of the cardio machine area, which includes treadmills, bikes, elliptical, stair steppers etc., and each of the TV's are able to be set to a different program channel. In order to provide club members the ability to listen to a desired TV channel, fitness facilities typically have to install a 900/800 MHz or an FM radio audio transmitter which is then connected to the audio output of each TV. This transmitter then broadcasts the audio to a receiver which is mounted onto or integrated into a cardio machine, where the TV speakers are either turned off or muted. In order to operate, the club member simply selects an identifier (such as a number located under the TV they desire to watch) on the receiver to listen to a particular TV using a personal set of headphones (which may be provided by the club or owned by the member) which are connected via a headphone jack on the cardio machine or audio receiver attached to the cardio machine. This type of system is commonly known in the commercial fitness industry as a ‘Wireless Cardio Entertainment System’ and it is estimated that over 30,000 health and fitness facilities utilize this type of Wireless Cardio Entertainment System.

Currently, a method for delivering the audio from a TV that is located in a public area to mobile devices has been introduced and where the method uses downloadable applications to facilitate this delivery. Essentially, this method obtains the audio signal from the TV or other audio source and converts the audio signal into a digital signal which is then broadcast over a standard Wi-Fi Network and played over a mobile device. Unfortunately however, this method does not work very well when the audio from multiple TVs or other audio sources (such as, for example, those seen in the commercial fitness industry) needs to be broadcasted over a Wi-Fi system. In order to implement such a system and method, the audio from each TV or other audio source must be provided to a central A/D converter and Wi-Fi server which would require hardwiring an audio cable from each TV or other audio source to the central A/D converter and Wi-Fi server. This is undesirable due to the high cost associated with this implementation and because the commercial fitness industry typically implements an ‘open layout’ where space is at a premium and appearance is important. And because the audio cables would be visible to customers, this would be unsightly and would detract from the appearance of the club.

### SUMMARY OF THE INVENTION

A signal control system is provided and includes a signal source, a receiving device communicated with the signal source and configured to receive a signal from the signal source, a processing device communicated with the receiving device to receive and process the signal to generate a resultant signal and a transmitting device communicated with the processing device, wherein the transmitting device is configured to wirelessly transmit the resultant signal.

A multi-channel signal processing device is provided and includes a receiver configured to receive a signal from a signal source, an analog/digital (A/D) converter communicated with the receiver and configured to convert the signal into a digital signal and a digital audio server (DAS) communicated with the A/D converter and configured to format the digital signal into a resultant signal.

A method for communicating a signal to a personal device is provided, wherein the method includes receiving a signal from a signal source, processing the signal to determine if the signal is an analog signal, wherein if the signal is an analog signal, communicating the signal to an analog/digital (A/D) converter to convert the analog signal into a processed signal and communicating the processed signal to a digital audio server (DAS), or if the signal is a digital signal, communicating the signal to the DAS. The method further includes generating a resultant signal, wherein the resultant signal is processed for display/play on a personal device and transmitting the resultant signal via a wireless device.

### BRIEF DESCRIPTION OF THE DRAWINGS

FIG. 1 is schematic block diagram illustrating a system for displaying television in an exercise facility, in accordance with the prior art.

FIG. 2A is schematic block diagram illustrating a system for transmitting a signal to a personal device, in accordance with one embodiment of the invention.

FIG. 2B is a schematic block diagram illustrating an operational flow of the system for transmitting a signal to a personal device of FIG. 2.

FIG. 3A is schematic block diagram illustrating a system for transmitting a signal to a personal device, in accordance with another embodiment of the invention.

FIG. 3B is schematic block diagram illustrating a system for transmitting a signal to a personal device, in accordance with yet another embodiment of the invention.

FIG. 4A is schematic block diagram illustrating a system for transmitting a signal to a personal device, in accordance with still yet another embodiment of the invention.

FIG. 4B is schematic block diagram illustrating a system for transmitting a signal to a personal device, in accordance with still yet another embodiment of the invention.

FIG. 5 is an operational block diagram illustrating a method for transmitting a signal to a personal device, in accordance with one embodiment of the invention.

FIG. 6 is schematic block diagram illustrating a system for transmitting a signal to a personal device, in accordance with still yet another embodiment of the invention.

### DETAILED DESCRIPTION OF THE INVENTION

It should be appreciated that the present invention provides a method and system for use in the commercial fitness industry to wirelessly communicate a signal (such as audio, video, or other type of signal) from one or more sources (such as a TV or other type of source) directly to the personal devices (i.e. PDA, smartphone, iPhone, Computer, etc . . . ) of club members, regardless of the type of personal device the club member uses. This advantageously provides the ability for the club member to listen to the TV audio throughout the fitness facility on their personal device rather than only on the cardio equipment (example: a member can begin watching a sporting event while on a treadmill and continue listening while working out in other areas of the facility) without the need for a particular device.

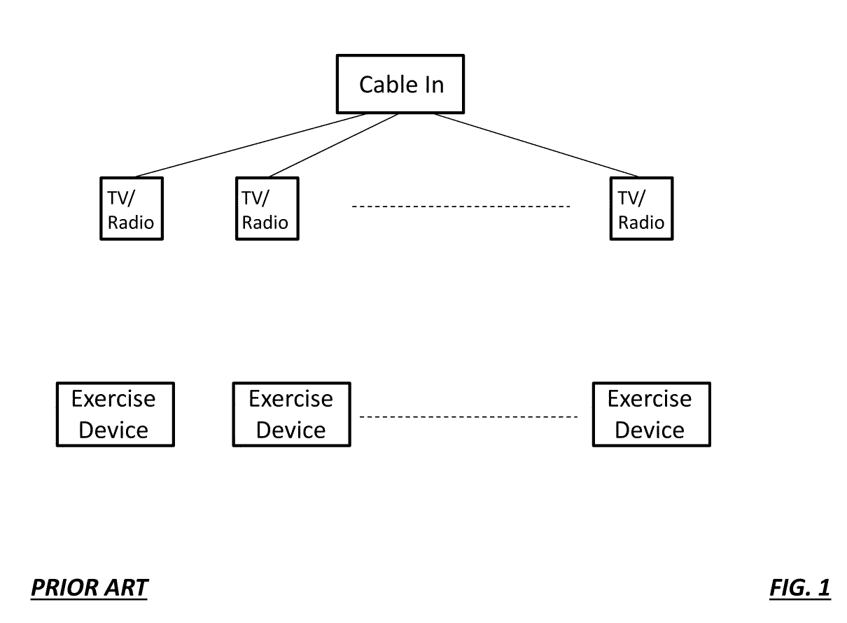

Typically, the majority of commercial health and fitness facilities utilize a basic cable TV service that is distributed to the individual TVs throughout the facility. A main cable feed from the cable company enters the building and the cable signal is typically routed to each TV using cable splitters (See FIG. 1) and a hardwired connection. It should be appreciated that TV audio signals are typically analog signals and in order to send the TV audio signals to a personal device, the analog TV audio signal may have to be converted into a digital signal which is configured for broadcast over a standard Wi-Fi network. The analog TV audio signal from each individual TV is routed to a main A/D Converter which converts the analog signal into a digital signal which is then broadcast over the Wi-Fi network via a Wi-Fi router.

As discussed briefly hereinabove, one obstacle in the installation of such a Wi-Fi based audio system involves the need to provide the audio from each TV directly to one central A/D Converter and Wi-Fi Server. This is because each TV has to be hardwired to a central A/D Converter and Wi-Fi Server. The present invention addresses this need by including a Multiple Channel Audio Receiver (MCAR) that eliminates the need to hardwire each TV audio signal directly to an A/D converter and Wi-Fi server. In accordance with one embodiment of the invention, the MCAR receives the TV audio signals via a wireless transmitter (operating at 900/800 MHz or another band as desired) that is associated with the TV. Once the audio signal from each TV is received by the MCAR, the audio signal is converted into a digital signal via an A/D converter, which may be integrated with or separate from the MCAR. This digital signal can then be transmitted through-out the club via the standard Wi-Fi server. As such, the present invention advantageously provides the ability for health club operators to offer Wi-Fi based TV audio for club members to listen to via a generic personal device having Wi-Fi capability, without having to hard wire each TV back to a main A/D Converter & Wi-Fi Server. Additionally, the present invention advantageously provides the ability to easily retrofit existing systems.

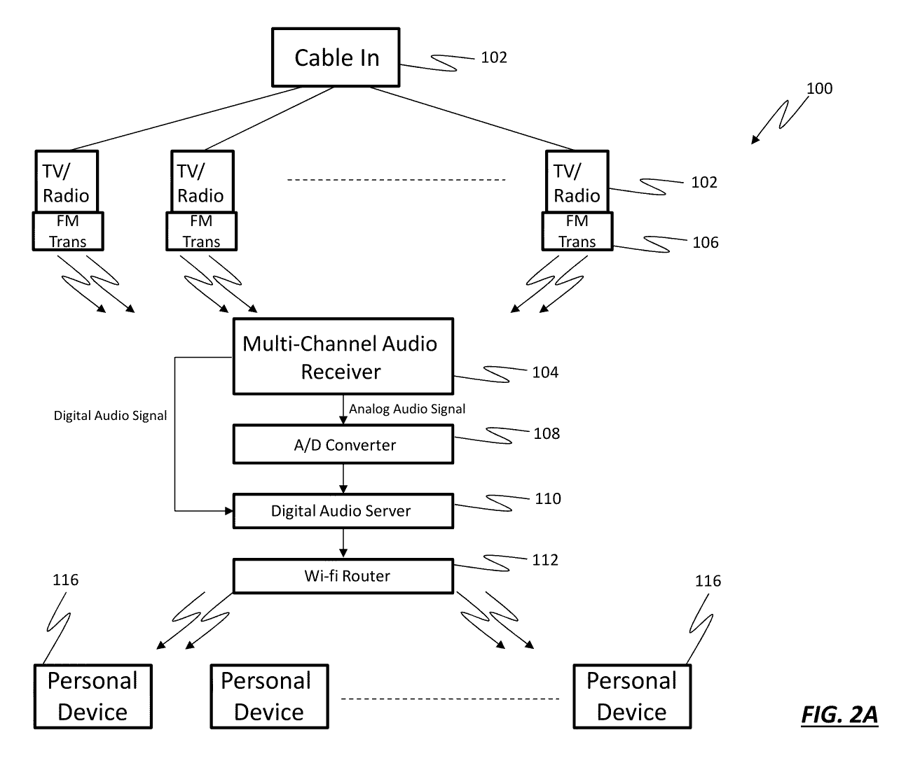

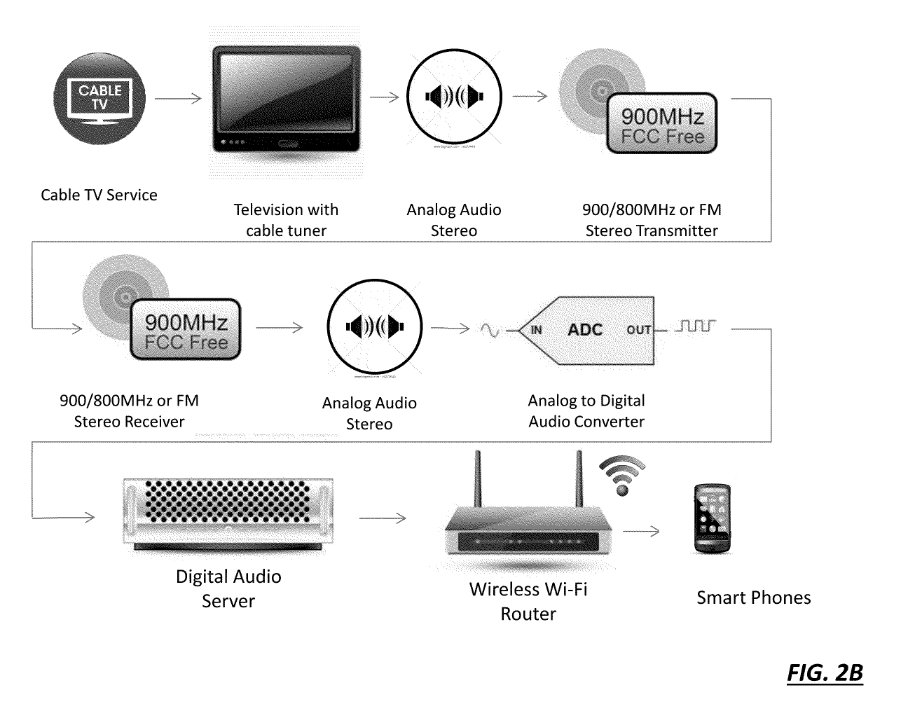

Referring to FIG. 2A and FIG. 2B, a schematic block diagram illustrating one embodiment a Multiple Channel Signal Control System (MCSCS) 100 is provided and includes one or more signal sources 102 and a Multiple Channel Audio Receiver (MCAR) 104 that is configured to receive one or more analog signals (video/audio) from the one or more signal sources 102 (such as a Television, radio, etc . . . ). Additionally, the MCSC 100 further includes a plurality of wireless transmitting devices 106, an A/D Converter 108, a Digital Audio Server (DAS) 110 and a Wi-Fi router 112. It should be appreciated that the MCAR 104 is configured to be in wireless communication with the wireless transmitting devices 106, wherein the wireless transmitting devices 106 are further associated with the TV's (or other audio source) such that each TV is associated with one wireless transmitting device 106. The A/D Converter 108 is associated with the MCAR 104 and the DAS 110 to be in signal communication with both the A/D Converter 108 and the MCAR 104 and the DAS 110. Furthermore, the DAS 110 is further associated with the Wi-Fi Router 112 to be in signal communication with the Wi-Fi Router 112 which is configured to broadcast Wi-Fi Signals.

It should be appreciated that the transmission of the analog signals between the components of the MCSCS 100 disclosed hereinabove may be accomplished via any method suitable to the desired end purpose. For example, the one or more analog signals received by the MCAR 104 may be communicated to the A/D Converter 108 via a hardwired connection and/or a wireless connection. This is also true for signal communication between the DAS 110, the A/D Converter 108 and the Wi-Fi Router 112. In one embodiment, the MCSCS 100 operates as follows wherein the MCAR 104 receives the one or more analog signal(s) (or portions thereof) from the one or more signal sources 102 and communicates the one or more analog signal(s) to the A/D Converter 108 which then converts the one or more analog signal(s) (or portions thereof) into one or more digital signals. The one or more digital signal(s) are then communicated to DAS 110 which may store and/or process the one or more digital signal(s) into one or more resultant digital signals having a format that can be broadcast via the Wi-Fi Router 112 and implemented (i.e. viewed/played) on one or more personal devices 116, such as PDA, smartphone, iPhone, Computer, etc . . . The resultant digital signal(s) may then be communicated to the Wi-Fi Router 112 which transmits the resultant digital signal(s) to the one or more personal devices 116 that have Wi-Fi capability.

It should be appreciated that each signal may freely broadcasted or they may be controllably accessed by a club member via an access/identifier code using their personal device 116. This controlled access may be accomplished by controlling the signal (and/or broadcast of the signal) via any method suitable to the desired end purpose, such as via the configurable MCAR 102 and/or the Wi-Fi router 112.

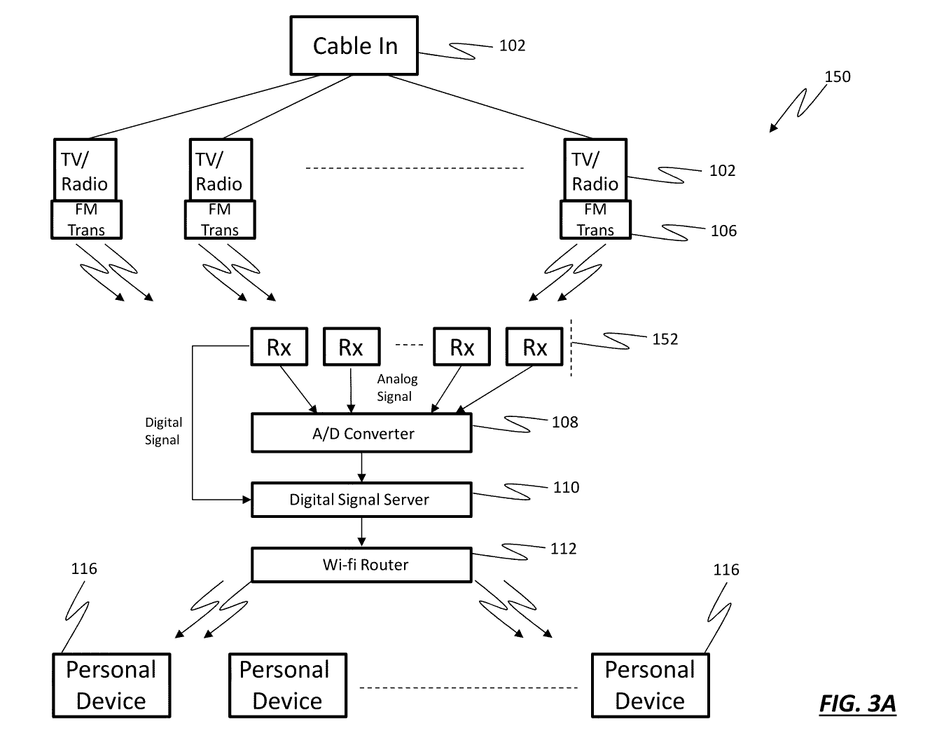

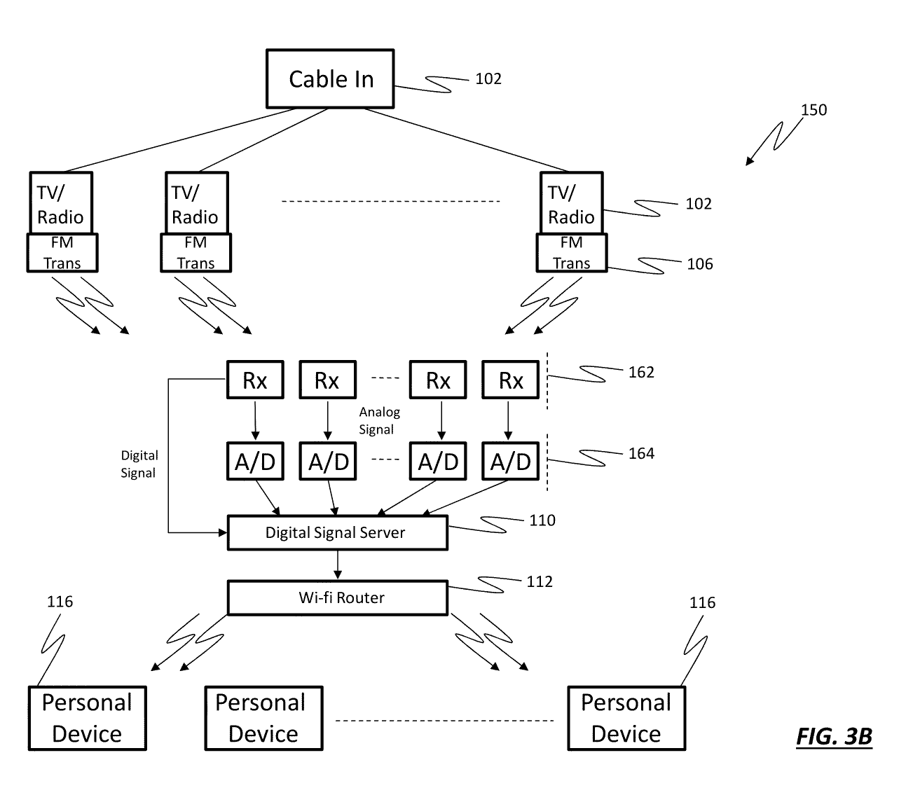

Additionally, it is contemplated that the Multiple Channel Signal Control System (MCSCS) 100 may receive, process and/or transmit Wi-Fi signals similar to that as disclosed hereinabove, but using multiple receivers for multiple signals. One such embodiment is shown in FIG. 3A, which illustrates another embodiment of the Multiple Channel Signal Control System (MCSCS) 150 and includes one or more receivers 152. Another embodiment is shown in FIG. 3B, which illustrates another embodiment of the Multiple Channel Signal Control System (MCSCS) 160 and includes one or more receivers 162 and one or more A/D Converters 164. It is contemplated that multiple Digital Signal Servers and/or multiple Wi-Fi routers could be used as well.

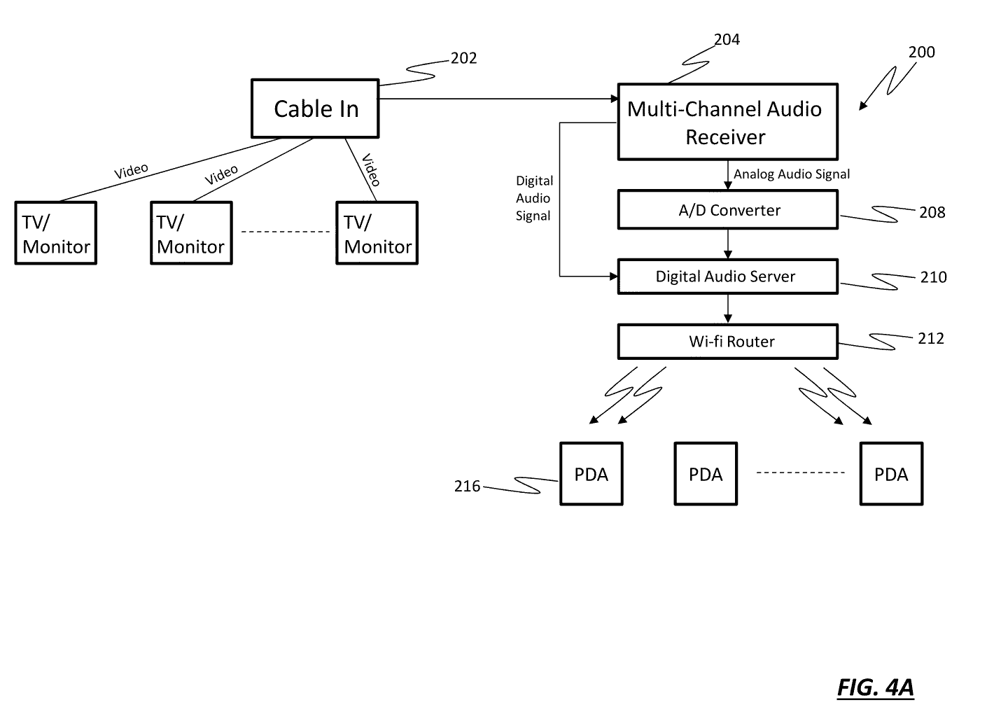

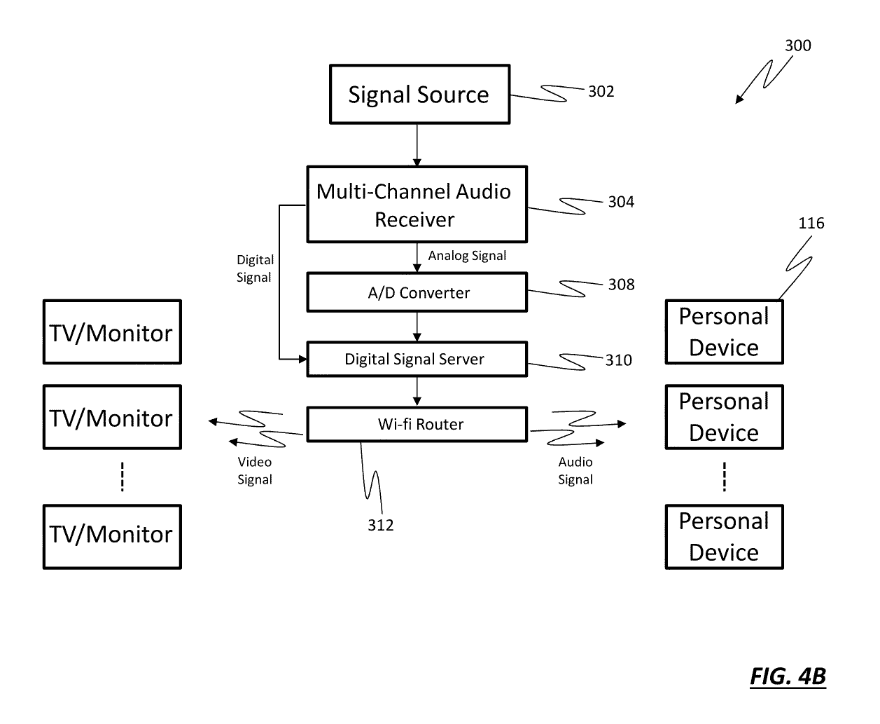

It should be appreciated that other embodiments are contemplated to be within the scope of the invention. For example, referring to FIG. 4A, in yet another embodiment of the MCSCS 200 the signal source 202 may be a cable input box which is directly connected (either hardwired or wirelessly) to the MCAR 104 which may then process the input signal to separate out the video signal and the analog audio signal. The MCAR 204 may then communicate the video signal to a TV for display and the analog audio signal to the A/D Converter 208 which converts the analog audio signal into a digital audio signal and communicates the digital audio signal to the DAS 210. The DAS 210 may then process the digital audio signal for broadcast via Wi-Fi and communicate the processed digital audio signal to the Wi-Fi Router 212 for broadcast.

Referring to FIG. 4B, in still yet another embodiment of the MCSCS 300, the signal source 302 may be a cable input box which is directly connected (either hardwired or wirelessly) to the MCAR 304 which may then communicate the input signal to the A/D Converter 308 which converts the analog signal into a digital signal and communicates the digital signal to the DAS 310. If the input signal has a digital component (such as video) then the digital component may bypass the A/D Converter 308 to be communicated directly to the DAS 310. The DAS 310 may then process the digital signal(s) for broadcast via Wi-Fi and communicate the processed digital signal to the Wi-Fi Router 312 for broadcast. It should be appreciated that in this embodiment, the DAS 310 would be configured to process audio and non-audio signals as desired. For example, the DAS 310 would be configured to process video signals. It should also be appreciated that in this embodiment, the video signal may be sent to the TV (or monitor) and the audio signal may be sent to the personal devices 116 via the Wi-Fi Router. Accordingly the TV's (or monitors) may need a Wi-Fi receiver to receive the Wi-Fi video signals. This would advantageously remove a substantial portion of the cables/wires required for current systems.

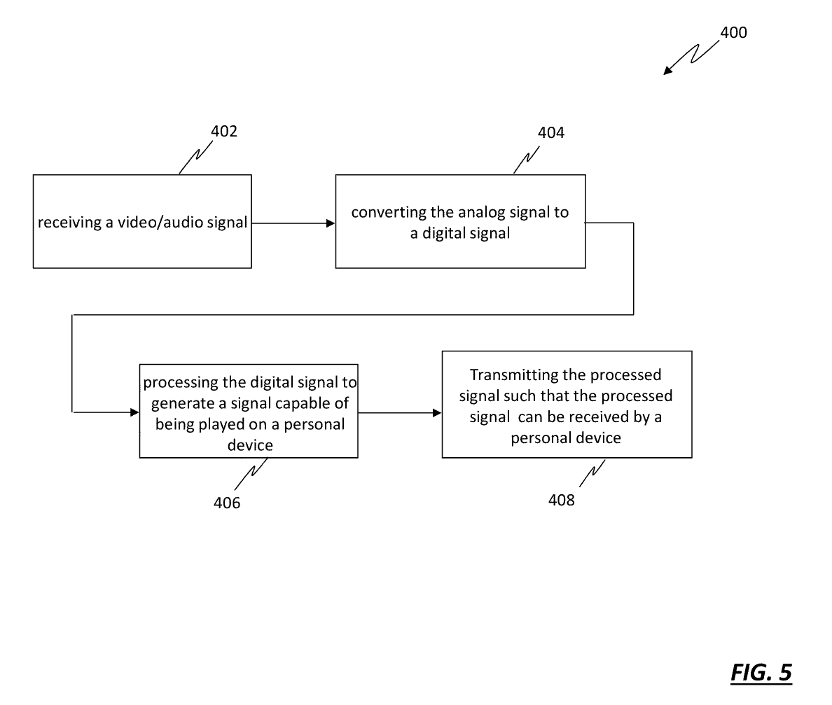

Referring to FIG. 5, an operational block diagram illustrating a method 400 for communicating an analog signal to a personal device 116 is illustrated, in accordance with one embodiment of the invention. The method 400 includes receiving a video/audio signal from a signal source 102 (such as a satellite or cable company, radio station, TV station, etc . . . ), as shown in operational block 402. This may be accomplished via an FM, satellite or cable receiver which is associated with the television, radio, web device, computer, or other device, such as a cable box, DishTV® box, DirectTV® box, etc. If the video/audio signal is analog (or contains analog components), then the video/audio signal is communicated to the analog/digital (A/D) converter 108 and converted into a digital signal, as shown in operational block 404. The digital signal is then communicated to the Digital Audio Server (DAS) 110 to be processed to generate a resultant digital signal that is formatted to be capable of being played via a personal device 116, as shown in operational block 406. It should be appreciated that if the video/audio signal is digital, then it is contemplated that the A/D conversion may be skipped and the received signal may be communicated directly to the DAS 110 for processing to generate a resultant digital signal that is formatted to be capable of being played via a personal device 116. Once the resultant digital signal is generated, the resultant digital signal is communicated to the Wi-Fi Router 112 for transmission via the Wi-Fi router such that the resultant signal can be received by any personal device 116 (such as a PDA, smartphone, iPhone, iPad, iComputer, etc . . . ) authorized to play the resultant digital signal, as shown in operational block 408. It should also be appreciated that it is contemplated that the facility may control access to the resultant digital signal to allow only members to receive the entire resultant digital signal, certain resultant digital signals, and/or only portions of the resultant digital signal. For example, the facility may control which members receive which resultant digital signal which may be based on membership level or some other parameter.

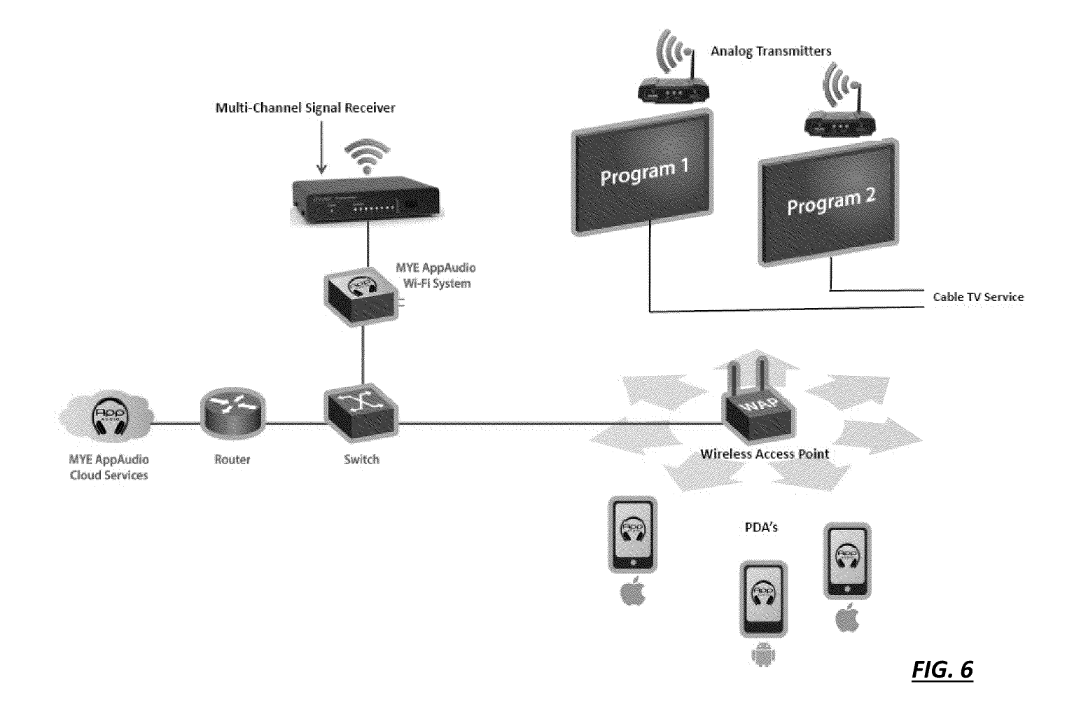

It should be appreciated that the present invention is not limited to the 900/800 MHz, FM band and/or any particular frequency band, but rather may be used with any frequency band as desired and/or suitable to the desired end purpose. Additionally, it is contemplated that the invention may be used with multiple frequency bands. Furthermore, while the invention is disclosed herein as using a Wi-Fi router to broadcast the resultant signal(s), the resultant signal(s) may be communicated via any broadcast method and/or system suitable to the desired end purpose, such as an Ethernet switch and/or a wireless access point (i.e. “Ubiquiti”) as shown in FIG. 6. One such system and method for communicating audio to a personal device would be that described in U.S. Pat. No. 8,495,236, the contents of which are incorporated by reference herein. Additionally, it is contemplated that the signal(s) may be formatted in any format suitable to the desired end purpose of communication to and operation on a personal device, such as, but not limited to, Wi-Fi (80-2.11a/b/g/n), Bluetooth and Cellular technology (UMTS/HSPA/HSPA+/DC-HSDPA; GSM/EDGE, CDMA EV-DO). It should be further appreciated that the MCAR, A/D Converter, Digital Signal Server and/or Wi-Fi router/Wireless access point may be individual components or they may be integrated into one or more units as desired.

It should be appreciated that although the method and apparatus of the invention is disclosed herein as being applicable to the fitness/health industry, it is contemplated that the method and apparatus of the invention may be used for any application suitable to the desired end purpose where multiple televisions, monitors and/or audio systems are used, such as for example (but not limited to), sports arenas (sporting events), restaurants/bars, education (classes), entertainment (concert events, conferences, etc . . . ), political events, etc.

In accordance with the present invention, the processing circuitry of the present invention is advantageously configurable to allow multiple video/audio sources to be received and transmitted as desired. Additionally, it should be appreciated that the invention as disclosed herein may be implemented as desired via any devices suitable to the desired end purpose, such as digital devices, analog devices and/or a combination of digital and analog devices. Additionally, although the invention is disclosed herein with regards to one device, it is contemplated to be within the scope of the invention that a plurality of devices may be connected together (or integrated together) to achieve the same or similar results.

In accordance with the present invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, the method of the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims and/or information. Moreover, unless specifically stated any use of the terms first, second, etc. do not denote any order or importance, but rather the terms first, second, etc. are used to distinguish one element from another.

We claim:

1. A signal control system, comprising:
a signal source;
a receiving device communicated with the signal source and configured to receive a signal from the signal source;
a processing device communicated with the receiving device to receive and process the signal to generate a resultant signal; and
a transmitting device communicated with the processing device, wherein the transmitting device is configured to wirelessly transmit the resultant signal.

2. The signal control system of claim 1, wherein the signal source includes at least one of a cable receiver, a satellite receiver, a television, a radio, a computer and an internet receiver.

3. The signal control system of claim 1, wherein the receiving device includes at least one of a television, a radio, a computer and an internet receiver.

4. The signal control system of claim 1, wherein the processing device is configured to determine if the signal is an analog signal.

5. The signal control system of claim 4, wherein the processing device includes an analog/digital (A/D) converter configured to convert the analog signal into a digital signal.

6. The signal control system of claim 5, wherein the processing device includes a Digital Audio Server (DAS) configured to generate the resultant signal by formatting the digital signal for implementation on a personal device.

7. The signal control system of claim 1, wherein the transmitting device is configured to transmit the resultant signal via a Wi-Fi network.

8. The signal control system of claim 1, wherein the resultant signal is formatted for implementation on a personal device.

9. The signal control system of claim 8, where the personal device includes at least one of a PDA, a smartphone, an iPhone, an iPad, an iTouch and a computing device.

10. A multi-channel signal processing device, comprising:
a receiver configured to receive a signal from a signal source;
an analog/digital (A/D) converter communicated with the receiver and configured to convert the signal into a digital signal; and
a digital audio server (DAS) communicated with the A/D converter and configured to format the digital signal into a resultant signal.

11. The multi-channel signal processing device of claim 10, further comprising a transmitting device communicated with the DAS and configured to wirelessly transmit the resultant signal.

12. The multi-channel signal processing device of claim 11, wherein the transmitting device is a Wi-Fi transmitting device.

13. The multi-channel signal processing device of claim 10, wherein the multi-channel signal processing device is configured to determine if the signal is analog or digital.

14. The multi-channel signal processing device of claim 13, wherein,
if the signal is digital, the multi-channel signal processing device is configured to by-pass the analog/digital (A/D) converter and communicate the signal to the digital audio server (DAS), and
if the signal is analog, the multi-channel signal processing device is configured to communicate the signal to the analog/digital (A/D) converter.

15. The multi-channel signal processing device of claim 10, wherein the resultant signal is formatted for implementation on a personal device

16. The multi-channel signal processing device of claim 15, where the personal device includes at least one of a PDA, a smartphone, an iPhone, an iPad, an iTouch and a computing device.

17. A method for communicating a signal to a personal device, the method comprising:
receiving a signal from a signal source;
processing the signal to determine if the signal is an analog signal, wherein
if the signal is an analog signal, communicating the signal to an analog/digital (A/D) converter to convert the analog signal into a processed signal and communicating the processed signal to a digital audio server (DAS), or
if the signal is a digital signal, communicating the signal to the DAS;
generating a resultant signal, wherein the resultant signal is processed for display/play on a personal device; and
transmitting the resultant signal via a wireless device.

18. The method of claim 17, wherein generating includes processing at least one of the signal and the processed signal to generate the resultant signal which is formatted to be compatible with the personal device.

19. The method of claim 17, wherein receiving includes receiving the signal from at least one of a cable receiver, a satellite receiver, a television, a radio, a computing device and an internet interface device.

20. The method of claim 17, where the personal device includes at least one of a PDA, a smartphone, an iPhone, an iPad, an iTouch and a computing device.
